(19) United States
(12) Patent Application Publication
(10) Pub. No.: US 2023/0312848 A1
(43) Pub. Date: Oct. 5, 2023

(54) Water-Soluble Film for Preparing a Beverage

(71) Applicant: The Coca-Cola Company, Atlanta, GA (US)

(72) Inventors: Sabine Bruestle, Atlanta, GA (US); Tom Hidvegi, Prague (CZ); Raluca Vlad, Segrate (IT); Viju Vasishta, Hertfordshire (GB); Anthony Arkell, Hertfordshire (GB)

(21) Appl. No.: 18/043,808

(22) PCT Filed: Sep. 10, 2021
(86) PCT No.: PCT/US2021/049807

§ 371 Date: Mar. 2, 2023

Related U.S. Application Data
(60) Provisional application No. 63/076,685, filed on Sep. 10, 2020.

(51) Int. Cl. C08J 5/18; C09D 105/00; A23F 3/30; A23F 3/22; A23P 20/10

(52) U.S. Cl. CPC C08J 5/18; C09D 105/00; A23F 3/30; A23F 3/22; A23P 20/10; C08J 2305/00; C08J 2401/10; C08J 2403/02; C08J 2371/02

(57) ABSTRACT

The present invention provides water-soluble films for preparing beverages comprising one or more tea, herbal or fruit extracts and a water-soluble polymer. Methods of preparing water-soluble films for preparing a beverage comprising: (i) combining (a) one or more tea, herbal or fruit extracts, (b) a water-soluble polymer, and optionally, (c) a plasticizer, in water to form a tea, herbal or fruit extract composition; (b) optionally, heating the tea, herbal or fruit extract composition to a temperature in the range of about 25° C. to about 100° C.; (iii) forming a layer of the tea, herbal or fruit extract composition on a surface; and (iv) drying the layer of the tea, herbal or fruit extract composition to form a water-soluble film.

### CROSS-REFERENCE TO RELATED APPLICATION

This application claims priority to U.S. Provisional Patent Application No. 63/076,685, filed Sep. 10, 2020, the entirety of which is incorporated herein.

### FIELD OF THE INVENTION

The present invention relates generally to water-soluble films which dissolve in water to produce a beverage and methods for preparing the films. The films can be shaped by folding to produce a sculpture or desired form.

### BACKGROUND OF THE INVENTION

For centuries, people across the globe have testified to the relaxing qualities of tea. The traditional calming effects of the plant Camellia sinensis have elevated the drink, which is produced from its leaves, to a role beyond quenching thirst; it is consumed as an aid for meditation, to help soothe the nerves or simply to unwind.

A cup of tea may be prepared by putting tea leaves or herbs, or conventional tea bags filled with the tea leaves or herbs, in a cup of hot or boiling water. For some teas, maintaining a certain steep time is required for producing the best flavor. Improper steeping of the tea leaves or herbs results in either incomplete or excessive extraction, which may adversely impact the taste and strength of the beverage.

Once the tea leaves, herbs or teabags have been steeped, they are removed from the beverage and discarded. If not properly strained, or if the tea bag breaks, the tea or herbal particles remain in the beverage, adding to the difficulty in controlling proper brewing time to obtain the most palatable taste.

An ever increasing proportion of tea marketed in the world is marketed in the form of tea extracts, usually in the form of dry powders or concentrated liquids. Such powders and liquids have been developed to provide a high quality beverage, upon reconstitution, having a flavor and color which is as close as possible to that obtained by brewing tea from tea leaf.

There remains a need for infusion products for making a tea and herbal beverages that allow for simple, fast infusion. There remains a need for products which promote the enhance or the calming or relaxing effects of tea.

### SUMMARY OF THE INVENTION

Described herein are water-soluble films which rapidly dissolve in water to produce a beverage or a tea. The films can be shaped, for example, in aesthetically-pleasing, unexpected forms, such as flowers, leaves, origami-like shapes, or Kirigami. The shape of the films may include folds and/or forms created from molds. The shape of the films enhances the delight or sense of theater for the tea-drinker when preparing the beverage made by dissolving the exemplary films in water.

In one aspect, the present invention provides a water-soluble film for preparing a beverage comprising (a) one or more tea, herbal or fruit extracts, (b) a water-soluble polymer, and optionally, (c) a plasticizer.

In a second aspect, the present invention provides a water-soluble film for preparing a beverage comprising (a) one or more tea, herbal or fruit extracts, (b) a water-soluble polymer, optionally, (c) a plasticizer, and (d) a water-soluble paper.

In certain embodiments, the water-soluble films are shaped, as described herein.

In a third aspect, the present invention provides methods for preparing the water-soluble films of the present invention. In one embodiment, the method comprises:
(i) combining (a) one or more tea, herbal or fruit extracts, (b) a water-soluble polymer, and optionally, (c) a plasticizer, in water to form a tea, herbal and/or fruit extract composition;
(ii) optionally, heating the tea, herbal and/or fruit extract composition to a temperature in the range of about 25° C. to about 100° C.;
(iii) forming a layer of the tea, herbal and/or fruit extract composition on a surface;
(iv) drying the layer of the tea, herbal and/or fruit extract composition to form a water-soluble film.

In certain embodiments, the method may further comprise step (v) shaping the water-soluble film.

In another embodiment, the method comprises:
(i) combining (a) one or more tea, herbal or fruit extracts, (b) a water-soluble polymer, and optionally, (c) a plasticizer, in water to form a tea, herbal and/or fruit extract composition;
(ii) optionally, heating the tea, herbal and/or fruit extract composition to a temperature in the range of about 25° C. to about 100° C.;
(iii) forming a layer of the tea, herbal and/or fruit extract composition on a water-soluble paper;
(iv) drying the layer of the tea, herbal and/or fruit extract composition to form a water-soluble film.

In certain embodiments, the method may further comprise step (v) shaping the water-soluble film.

### DETAILED DESCRIPTION OF THE INVENTION

### I. Definitions

The term “film”, as referred to herein, means a thin layer of a substance or multiple thin layers of one or more substances. For example, a film may be a thin layer of a composition or a thin layer of one composition in contact with a thin layer of another composition. The thin layers made be in the form of a tea, herbal and/or fruit extract composition or a water-soluble paper. For example, the film comprises a thin layer of a tea, herbal and/or fruit extract composition in contact with a thin layer of a water soluble paper. In the present invention, such thin layers may be of a thickness in the range of about 0.2 to about 3 mm, or about 1 to about 2 mm. In certain embodiments, the thin layer of tea, herbal and/or fruit extract composition may be of a thickness in the range of about 1 mm to about 3 mm when wet. In certain embodiments, the thickness of the layer of water-soluble paper is in the range of about 0.1 mm to 0.3 mm. In certain embodiments, the thickness of the layer of water-soluble paper is about 0.2 mm. In certain embodiments, the thickness of the film comprising a thin layer of a tea, herbal and/or fruit extract composition in contact with a thin layer of a water soluble paper is in the range of about 1 mm to about 3.2 mm wet, or about 0.3 mm to about 1 mm dry.

A film that is “water-soluble”, as referred to herein, is one that dissolves in water, dissolves in contact with an aqueous solution (i.e. a solution containing water), or dissolves when agitated in water, for example by stirring in water.

A film that is “shaped” may be shaped by any suitable means, including but not limited to folding, cutting (e.g., laser-cutting, blade-cutting), stamping, molding or any other decorative technique known in the art. The water-soluble film may be shaped to produce a sculpture or desired form, for example as in the art of origami wherein a sheet of paper is shaped into a sculpture through folding and sculpting techniques. The water-soluble film is shaped by folding and cutting of the film to produce a sculpture or form, as in the art of Kirigami wherein a sheet of paper is shaped by a combination of folds and cuts to the paper. In certain embodiments, the film is “foldable” or is one that is capable of folding, for example through 0° to 180°, without breaking. “Foldable” films can be bent or brought into compact form by bending and laying parts together.

As referred to herein, the term “tea”, “tea leaf” or “tea extract” refers to a product or beverage made from the leaves of the traditional tea plant (Camellia sinensis). The tea can be any desired type of tea, for example, white, yellow, green, oolong, black, red, post-fermented, or a mixture thereof. The tea, tea leaf or tea extract is, for example, in the form of freeze-dried tea, powdered tea, “instant” tea, liquid tea concentrate, or freshly brewed tea.

As referred to herein, the term “herbal tea” or “herbal extract” includes any Camellia sinensis-free product or beverage prepared by water infusion of plant material, usually leaves, flowers, roots, bark, nuts or other parts. Generally, the herb tea or herbal extract is derived from parts of the plant other than the fruit. Herbal extracts prepared by extraction of the plant material with solvents other than water, for example alcohols=ic solvents or oils, are also included. Exemplary plant materials for use in producing herbal teas or herbal extracts include but are not limited to: chamomile, peppermint, hibiscus, marigold, chrysanthemum, ginger, turmeric, and the like, and combinations thereof.

As referred to herein, the term “fruit extract” refers includes fruit juices and extracts of fruits. Generally, although the fruit extract may be produced from fruit peels, seeds and/or pulp, the fruit extract does not comprise substantial amounts of fruit peels, seeds and/or pulp. Substantial amounts of fruit peels, seeds and/or pulp in the fruit extracts, when used to prepare the water-soluble films according the embodiments, could produce a residue or solids when the film is dissolved in water to produce a beverage. Any suitable fruit extract could be used according to the embodiments. Exemplary fruits that could be used to produce a fruit extract include, but are not limited to: apple, pear, lemon, lime, mandarin, tangerine, grapefruit, cranberry, orange, strawberry, grape, kiwi, pineapple, passion fruit, mango, guava, raspberry and cherry, grapefruit, orange, lemon, lime, mandarin, mango, passion fruit, guava, and the like, and combinations thereof.

As used herein, the term “juice” means whole, concentrated or diluted juice from fruits, vegetables or other produce which are squeezed or crushed to supply a liquid.

### II. Water-Soluble Films

In a first aspect, the present invention is a water-soluble film for preparing a beverage comprising (a) one or more tea, herbal or fruit extracts, (b) a water-soluble polymer, and optionally, (c) a plasticizer. In one embodiment, the present invention is a water-soluble film for preparing a beverage comprising a tea, herbal or fruit composition, wherein the tea, herbal or fruit composition comprises (a) one or more tea, herbal or fruit extracts, (b) a water-soluble polymer, and optionally, (c) a plasticizer.

In a second aspect, the present invention is a water-soluble film for preparing a beverage comprising (a) one or more tea, herbal or fruit extracts, (b) a water-soluble polymer, optionally, (c) a plasticizer, and (d) a water-soluble paper. In one embodiment, the present invention is a water-soluble film for preparing a beverage comprising a tea, herbal or fruit composition and a water-soluble paper, wherein the tea, herbal or fruit composition comprises (a) one or more tea, herbal or fruit extracts, (b) a water-soluble polymer, and optionally, (c) a plasticizer.

In certain embodiments, the present invention includes a tea, herbal or fruit composition which is used alone or in combination with a water-soluble paper to produce a water-soluble film for preparing a beverage, wherein the tea, herbal or fruit composition comprises (a) one or more tea, herbal or fruit extracts, (b) a water-soluble polymer, and optionally, (c) a plasticizer. The water-soluble films can be comprised of a composition of the one or more tea, herbal or fruit extracts, water-soluble polymer, and optionally, a plasticizer; or the films can be comprised of a composition of the one or more tea, herbal or fruit extracts, water-soluble polymer, and optionally, a plasticizer cast on the water-soluble paper.

In certain embodiments, the layers of tea, herbal or fruit composition and water-soluble paper form discrete layers. In certain embodiments, the layers of tea, herbal or fruit composition and water-soluble paper are not discrete layers, e.g. the tea, herbal or fruit composition may absorb partially or completely into the water-soluble paper.

In an additional aspect, the present invention is a water-soluble film for preparing a beverage comprising: one or more tea, herbal or fruit extracts; a water-soluble paper, and optionally, a plasticizer. In one embodiment, the present invention is a water-soluble film for preparing a beverage comprising a tea, herbal or fruit composition, wherein the tea, herbal or fruit composition comprises: one or more tea, herbal or fruit extracts; a water-soluble paper, and optionally, a plasticizer. The films may further comprise a solvent, such as water or an aqueous solution. The amount of the solvent is any suitable amount which does not prevent the film from setting.

The water-soluble films dissolve in water to produce a beverage or a tea. Generally, once the water-soluble, shaped films have dissolved there is substantially no residue or solids visible in the beverage. In certain embodiments, the temperature of the water for dissolving the water-soluble films at least about 5° C., 10° C., 15° C., 20° C., 25° C., 30° C., 35° C., 40° C., 45° C., 50° C., 55° C., 60° C., 65° C., 70° C., 75° C., 80° C., 85° C., 90° C., or 95° C. In certain embodiments, the temperature of the water for dissolving the water-soluble films is in the range of about 5° C. to about 95° C., about 5° C. to about 60° C., about 5° C. to about 50° C., about 5° C. to about 40° C., about 5° C. to about 30° C., about 5° C. to about 20° C., about 20° C. to about 80° C., about 20° C. to about 60° C., about 20° C. to about 70° C., about 60° C. to about 95° C., about 70° C. to about 95° C., or about 80° C. to about 95° C.

In certain embodiments, the water-soluble films dissolve completely in cold (e.g., about 5° C. to about 20° C.) water. In one embodiment, the water-soluble films are at least about 90% dissolved within about 2 minutes, about 1 minute or about 30 seconds in cold (e.g., about 5° C. to about 20° C.) water.

In certain embodiments, the water-soluble films dissolve completely in hot (e.g., greater than about 80° C.) water or near-boiling water. In one embodiment, the water-soluble films are at least about 90% dissolved after about 2 minutes or less in hot (e.g., greater than about 80° C.) water or near-boiling water. In one embodiment, the water-soluble films are at least about 90% dissolved after about 30 seconds or less in hot (e.g., greater than about 80° C.) water or near-boiling water. In one embodiment, the water-soluble films are at least about 95% dissolved after about 2 minutes or less in hot (e.g., greater than about 80° C.) water or near-boiling water. In one embodiment, the water-soluble films are at least about 80% dissolved after about 30 seconds or less in hot (e.g., greater than about 80° C.) water or near-boiling water.

In certain embodiments, a film as described herein may be used to provide a single serving of tea, herbal or fruit beverage, for example a film may be dissolved in about 50 mL to about 450 mL, about 100 mL to about 400 mL (or about 1.7 ounces to about 15.2 ounces, or about 3.4 ounces to about 13.5 ounces) of water to provide a single serving of tea, herbal or fruit beverage. In certain embodiments, a film as described herein, for use in preparing a single serving of tea, herbal or fruit beverage has a dry weight in the range of about 0.5 g to about 5 g, about 0.5 g to about 4 g, about 0.5 g to about 3 g, about 1 g to about 5 g, about 1 g to about 4 g, about 1 g to about 3 g, about 2 to about 5 g, about 2 g to about 4 g, about 2 g to about 3 g, about 2.5 to about 5 g, about 2.5 to about 4 g, or about 2.5 g to about 3 g. In certain embodiments, the film used to provide a single serving of tea, herbal or fruit beverage may have a three-dimensional shape, for example a leaf, and have a dry weight in the range of about 2.5 g to about 4 g.

In certain embodiments, the water-soluble films can be dissolved in a minimum of about 50 mL of water (e.g., hot water) for a single serving. In certain embodiments, the water-soluble films can be dissolved in a minimum of about 50 mL of water (e.g., hot water) per about 0.5 g to about 5 g, about 0.5 g to about 4 g, or about 0.5 g to about 3 g of film. In certain embodiments, the water-soluble films can be dissolved in about 50 mL to about 450 mL, or about 100 mL to about 400 mL of water per about 0.5 g to about 5 g, about 0.5 g to about 4 g, or about 0.5 g to about 3 g of film to provide a tea, herbal or fruit beverage.

The films may also be prepared in larger sizes for use in preparing two or more (e.g., multiple) servings or a teapot of tea or herbal beverages. In certain embodiments, a film as described herein may be used to provide two or more (e.g., multiple) servings of tea, herbal or fruit beverage, for example a film may be dissolved in about 100 mL to about 900 mL, about 200 mL to about 800 mL (or about 3.4 ounces to about 30.4 ounces, or about 6.8 ounces to about 27 ounces) of water to provide two or more servings of tea, herbal or fruit beverage. In certain embodiments, a film as described herein, for use in preparing two or more servings of tea, herbal or fruit beverage has a dry weight in the range of about 1 g to about 10 g, about 1 g to about 8 g, about 1 g to about 6 g, about 2 g to about 10 g, about 2 g to about 8 g, about 2 g to about 6 g, about 4 to about 10 g, about 4 g to about 8 g, about 4 g to about 6 g, about 5 to about 10 g, about 5 to about 8 g, or about 5 g to about 6 g. In certain embodiments, the film used to provide two or more servings of tea, herbal or fruit beverage may have a three-dimensional shape, for example a leaf, and have a dry weight in the range of about 5 g to about 8 g.

In certain embodiments, the water-soluble films can be dissolved in a minimum of about 100 mL of water (e.g., hot water) for two or more (e.g., multiple) servings. In certain embodiments, the water-soluble films can be dissolved in a minimum of about 100 mL of water (e.g., hot water) per about 1 g to about 10 g, about 1 g to about 8 g, or about 1 g to about 6 g of film. In certain embodiments, the water-soluble films can be dissolved in about 100 mL to about 900 mL, or about 200 mL to about 800 mL of water per about 1 g to about 10 g, about 1 g to about 8 g, or about 1 g to about 6 g of film to provide a tea, herbal or fruit beverage.

In certain embodiments, the taste and concentration of the water soluble films after dissolution in water is equivalent to or better than the taste and concentration of tea made from placing a teabag or instant tea in a similar amount of water.

The water-soluble films can be shaped or folded into various 3-dimensional forms or shapes, such as flowers, leaves, origami-like shapes, or Kirigami. The forms or shapes may include cut features, folded features and decorative surface features. The water-soluble films may be folded, for example folded through an angle of 180°. The water-soluble films may be laser-cut, blade-cut, stamped, molded, layered, or decorated by another suitable method.

Generally, tea refers to drinks, or water-based infusions, made from the leaves of Camellia sinensis. The tea can be any desired type of tea, for example, white, yellow, green, oolong, black, red, post-fermented, or a mixture thereof. In certain embodiments, the tea extract is black tea. In certain embodiments, the tea extract consists essentially of black tea.

In certain embodiments, the tea, herbal or fruit extract is an extract of any desired tea, herbal plant material or fruit. In certain embodiments, the tea or tea extract, is for example tea in the form of freeze-dried tea, powdered tea, “instant” tea, liquid tea concentrate, or freshly brewed tea. In certain embodiments, the tea extract comprises freeze-dried tea. In certain embodiments, the freeze dried tea is in the form of granules. In certain embodiments, the freeze-dried tea is prepared by spray drying. In one embodiment, the tea is freeze-dried or powdered black tea. In certain embodiments, the tea extract comprises powdered tea. In certain embodiments, the powdered tea is in the form of granules. In certain embodiments, the powdered tea is prepared by spray drying. In one embodiment, the tea extract comprises liquid tea concentrate. In certain embodiments, the liquid tea concentrate includes a stabilizer. In one embodiment, the tea extract comprises freshly brewed tea.

In certain embodiments, the tea, herbal or fruit extract comprises one or more herbal extracts. As referred to herein, the term “herbal tea” or “herbal extract” includes any Camellia sinensis-free product or beverage prepared by water infusion of plant material, usually leaves, flowers, roots, bark, nuts or other parts. Generally, the herb tea or herbal extract is derived from parts of the plant other than the fruit. Herbal extracts prepared by extraction of the plant material with solvents other than water, for example alcoholic solvents or oils, are also included. Exemplary plant materials for use in producing herbal teas or herbal extracts include but are not limited to: chamomile, peppermint, hibiscus, marigold, chrysanthemum, ginger, turmeric, and the like, and combinations thereof.

The herbal extract may be derived from any suitable plant source. As used herein, herbs are any plants used for flavoring, food, medicine, or fragrance. Exemplary herbal extracts include, but are not limited to, an extract of an herb selected from the group consisting of rooibos, peppermint, spearmint, chamomile, pine bud, lemon balm, rosemary, lavender, chrysanthemum and mixtures thereof. In certain embodiments, the tea or herbal extract is present in an amount ranging from about 20% to about 99%, about 30% to about 99%, about 40% to about 99%, about 50% to about 99%, about 60% to about 99%, about 70% to about 99%, about 20% to about 96%, about 30% to about 96%, about 40% to about 96%, about 50% to about 96%, about 60% to about 96%, or about 70% to about 96%, weight part (w/w) based on the weight of total film.

In certain embodiments, the tea, herbal or fruit extract comprises one or more fruit extracts. As referred to herein, the term “fruit extract” refers includes fruit juices and extracts of fruits. Generally, although the fruit extract may be produced from fruit peels, seeds and/or pulp, the fruit extract does not comprise substantial amounts of fruit peels, seeds and/or pulp. Substantial amounts of fruit peels, seeds and/or pulp in the fruit extracts, when used to prepare the water-soluble films according the embodiments, could produce a residue or solids when the film is dissolved in water to produce a beverage. Any suitable fruit extract could be used according to the embodiments. Exemplary fruits that could be used to produce a fruit extract include, but are not limited to: apple, pear, lemon, lime, mandarin, tangerine, grapefruit, cranberry, orange, strawberry, grape, kiwi, pineapple, passion fruit, mango, guava, raspberry and cherry, grapefruit, orange, lemon, lime, mandarin, mango, passion fruit, guava, and the like, and combinations thereof.

As used herein, the term “juice” means whole, concentrated or diluted juice from fruits, vegetables or other produce which are squeezed or crushed to supply a liquid.

The tea and herbal extract are not particularly limited, and may be mixed with any desired, edible plant material. In certain embodiments, the water-soluble film may comprise vegetables or vegetable extracts. In certain embodiments, the water-soluble film may comprise one or more spices, for example turmeric or ginger. As used herein, a spice is a dried seed, fruit, root, bark, or vegetative substance primarily used for flavoring, coloring or preserving food.

In certain embodiments, the water-soluble polymer is a polymer that dissolves in water, for example water at a temperature of about 5° C. to about 99° C., about 10° C. to about 99° C., about 20° C. to about 99° C., about 30° C. to about 99° C., about 40° C. to about 99° C., about 50° C. to about 99° C., about 60° C. to about 99° C., about 70° C. to about 99° C., about 80° C. to about 99° C., or about 90° C. to about 99° C. In certain embodiments, the water-soluble polymer is a polymer that is edible or suitable for human consumption. In certain embodiments, the water-soluble polymer is a gelling agent. Exemplary water-soluble polymers include, but are not limited to, carboxymethyl cellulose, starch, gelatin, pectin, hydroxypropyl methyl cellulose, hydroxyl propyl cellulose, sodium carboxymethyl cellulose, alginate, sodium alginate, casein, whey protein isolates, soy protein isolates, zein, levan, elsinan, gluten, acasia gum, Arabia gum, guar gum, locust bean gum, xanthan gum, gellan gum, agar, and mixtures thereof. In certain embodiments, the water-soluble polymer is selected from the group consisting of carrageenan, pullulan, carboxymethyl cellulose, starch and mixtures thereof. In one embodiment, the water-soluble polymer is carrageenan. Carrageenan is a linear kappa sulphated polysaccharide extracted from red edible seaweeds. In one embodiment, the water-soluble polymer is pullalan. Pullulan is a polysaccharide polymer produced from starch by the fungus Aureobasidium pullulans.

In certain embodiments, the water-soluble polymer is added to the tea, herbal or fruit extract composition.

In certain embodiments, the water-soluble polymer is present in an amount ranging from about 0.002 to about 6, about 0.005 to about 6, 0.01 to about 6, 0.1 to about 6, 0.2 to about 6, about 0.4 to about 6, about 0.002 to about 3, about 0.005 to about 3, 0.01 to about 3, 0.1 to about 3, 0.2 to about 3, or about 0.4 to about 3 weight part (w/w) based on the weight of total film.

In certain embodiments, the water-soluble film comprises a plasticizer. The term “plasticizer”, as referred to herein, includes all suitable available material which can control the flexibility of film. Exemplary plasticizers include, but are not limited to, polyethylene glycol, sorbitol, maltitol, xylitol, glycerin, concentrated glycerin, and propylene glycol, and combinations thereof. In one embodiment, the plasticizer is polyethylene glycol, such as PEG 6000 or PEG 400. In certain embodiments, the plasticizer is present in an amount ranging from about 0.002 to about 5, about 0.005 to about 5, 0.01 to about 5, 0.1 to about 5, 0.2 to about 5, about 0.4 to about 5, about 0.002 to about 3, about 0.005 to about 3, 0.01 to about 3, 0.1 to about 3, 0.2 to about 3, or about 0.4 to about 3 weight part (w/w) based on the weight of total film.

In certain embodiments, the water-soluble film comprises a water-soluble paper. In certain embodiments, the water-soluble paper is layered with the tea, herbal or fruit extract composition. Exemplary water-soluble papers include but are not limited to carboxymethylcellulose and starch-based papers, for example Smartsolve® paper. Carboxymethylcellulose (CMC) is typically derived from wood or cotton. Mixtures of CMC and starch can be used to provide paper-like sheets that dissolve rapidly in water. In certain embodiments, the size of the paper used for each beverage prepared by the water-soluble film has an area of about 2000 mm² to about 5000 mm², about 2500 mm² to about 4500 mm², or about 3000 mm² to about 4000 mm² for a single serving per film. In certain embodiments, the size of the paper used for each beverage prepared by the water-soluble film is in the range of about 20 mm to about 100 mm, about 30 mm to about 90 mm, about 40 mm to about 80 mm, length per side.

In certain embodiments, the size of the paper used for two or more (e.g., multiple) beverages prepared by the water-soluble film has an area of about 4000 mm² to about 10000 mm², about 5000 mm² to about 9000 mm², or about 6000 mm² to about 8000 mm² for a two or more servings per film. In certain embodiments, the size of the paper used for each beverage prepared by the water-soluble film is in the range of about 40 mm to about 200 mm, about 60 mm to about 180 mm, about 80 mm to about 160 mm, length per side.

In certain embodiments, the water-soluble film may further comprise an emulsifier. The term “emulsifier” as referred to herein, includes all available emulsifiers which can improve the stability of the film. Exemplary emulsifiers include, but are not limited to, poly glycerin fatty acid ester, sucrose concentrated glycerin, sucrose fatty acid ester, glycerin fatty acid ester, soybean lecithin, polysorbate, sorbitan fatty acid ester, trioleic acid sorbitan, guar gum, cetanol, yolk lecithin, polyoxyethylene hydrogenated castor oil, lauromacrogol, and combinations thereof. In certain embodiments, the emulsifier is present in an amount ranging from about 0.001 to about 0.01 weight part (w/w) based on the weight of total film.

In certain embodiments, the water-soluble film further comprises a fragrance. The term “fragrance” defined herein comprises all available fragrance, including natural fragrances, artificial fragrances and combinations thereof. Exemplary natural fragrances, include but are not limited to, extracts of leaf, flower or fruits; or oils such as spearmint oil, cinnamon oil, peppermint oil, lemon oil and the like. Exemplary artificial fragrances, include but are not limited to artificial, synthetic fragrance of fruit(s) selected from the group consisting of lemon, orange, grape, lime, strawberry and the like or the artificial synthetic fragrance selected from the group consisting of vanilla, chocolate, coffee, cocoa, pine bud, ginseng, red ginseng, citrus and the like. In certain embodiments, the fragrance is present in an amount ranging from about 0.001 to about 0.01 weight part (w/w) based on the weight of total film. In certain embodiments, the fragrance can be used with emulsifier to be blended into water-soluble substances.

In certain embodiments, the water-soluble films have no sweetener added. In certain embodiments, the water-soluble films have no sugar added. In In other embodiments, the water-soluble films of the present invention contain one or more sweeteners. The sweetener can be caloric or non-caloric.

The sweetener can be a natural sweetener, a natural high potency sweetener or synthetic sweetener. As used herein, the phrase “natural high potency sweetener” (NHPS) refers to any sweetener found naturally in nature and characteristically has a sweetness potency greater than sucrose, fructose, or glucose, yet has less calories. The natural high potency sweetener can be provided as a pure compound or, alternatively, as part of an extract. As used herein, the phrase “synthetic sweetener” refers to any composition which is not found naturally in nature and characteristically has a sweetness potency greater than sucrose, fructose, or glucose, yet has less calories.

Non-limiting examples of NHPSs includes stevia and steviolglycosides, such as rebaudioside M, rebaudioside D, rebaudioside A, rebaudioside N, rebaudioside 0, rebaudioside E, steviolmonoside, steviolbioside, rubusoside, dulcoside B, dulcoside A, rebaudioside B, rebaudioside G, stevioside, rebaudioside C, rebaudioside F, rebaudioside I, rebaudioside H, rebaudioside L, rebaudioside K, rebaudioside J, rebaudioside M2, rebaudioside D2, rebaudioside S, rebaudioside T, rebaudioside U, rebaudioside V, rebaudioside W, rebaudioside Z1, rebaudioside Z2, rebaudioside IX, enzymatically glucosylated steviol glycosides and combinations thereof.

Another exemplary NHPS is Luo Han Guo and the related mogroside compounds, such as grosmogroside I, mogroside IA, mogroside IE, 11-oxomogroside IA, mogroside II, mogroside II A, mogroside II B, mogroside II E, 7-oxomogroside II E, mogroside III, Mogroside IIIe, 11-oxomogroside IIIE, 11-deoxymogroside III, mogroside IV, Mogroside IVA 11-oxomogroside IV, 11-oxomogroside IVA, mogroside V, isomogroside V, 11-deoxymogroside V, 7-oxomogroside V, 11-oxomogroside V, isomogroside V, mogroside VI, mogrol, 11-oxomogrol, siamenoside I, isomers of siamenoside I (e.g. those disclosed in 20170119032; incorporated by reference in its entirety), (3β,9β,10α,11α,24R)-3-[(4-O-β-D-glucospyranosyl-6-O-β-D-glucopyranosyl]-25-hydroxyl-9-methyl-19-norlanost-5-en-24-yl-[2-O-β-D-glucopyranosyl-6-O-β-D-glucopyranosyl]-β-D-glucopyranoside); (3β, 9β, 10α, 11α, 24R)-[(2-O-β-D-glucopyranosyl-6-O-β-D-glucopyranosyl-β-D-glucopyranosyl)oxy]-25-hydroxy-9-methyl-19-norlanost-5-en-24-yl-[2-O-β-D-glucopyranosyl-6-O-β-D-glucopyranosyl]-β-D-glucopyranoside); and (3β, 9β, 10α, 11α, 24R)-[(2-O-β-D-glucopyranosyl-6-O-β-D-glucopyranosyl-β-D-glucopyranosyl)oxy]-25-hydroxy-9-methyl-19-norlanost-5-en-24-yl-[2-O-β-D-glucopyranosyl-6-O-β-D-glucopyranosyl]-β-D-glucopyranoside),

Other exemplary NHPSs include monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I.

In one embodiment, the sweetener is a carbohydrate sweetener. Suitable carbohydrate sweeteners include, but not limited to, the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, arabinose, turanose, sialose and combinations thereof.

Other suitable sweeteners include siamenoside, monatin and its salts (monatin SS, RR, RS, SR), curculin, mogrosides, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, steviolbioside and cyclocarioside I, sugar alcohols such as erythritol, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

In another embodiment, the sweetener is a rare sugar selected from allulose, gulose, kojibiose, sorbose, lyxose, ribulose, xylose, xylulose, D-allose, L-ribose, D-tagatose, L-glucose, L-fucose, L-arabinose, turanose and combinations thereof.

In certain embodiment, the sweetener may include, but is not limited to acesulfame potassium, sucralose, xylitol, mannitol, sucrose, dextrose, or combinations thereof, and the like.

In certain embodiments, the water-soluble films can further include one or more flavor agents, color agents and/or fruit acids. Suitable flavoring agents may be any natural or artificial flavor desired and may range from single fruit flavors such as peach, apricot, raspberry, lemon, strawberry, cherry, blueberry, pineapple, orange, vanilla, banana, coconut, chocolate, chocolate mint, chocolate mocha, etc. and blends thereof. Suitable color agents can be any approved ingredient.

Exemplary color agents include, anthocyanins, betacyanins, annatto extract, dehydrated beets (beet powder), canthaxanthin, caramel, β-Apo-8′-carotenal, β-carotene, cochineal extract, carmine, sodium copper chlorophyllin, toasted partially defatted cooked cottonseed flour, ferrous gluconate, ferrous lactate, grape color extract, grape skin extract (enocianina), synthetic iron oxide, fruit juice, vegetable juice, carrot oil, paprika, paprika oleoresin, mica-based pearlescent pigments, riboflavin, saffron, spirulina extract, titanium dioxide, tomato lycopene extract or concentrate, turmeric, turmeric oleoresin, FD&C Blue No. 1, FD&C Blue No. 2, FD&C Green No. 3, Orange B, Citrus Red No. 2, FD&C Red No. 3, FD&C Red No. 40, FD&C Yellow No. 5, FD&C Yellow No. 6 and blends thereof.

Exemplary fruit acids, include but are not limited to, citric acid, malic acid or tartaric acid.

In one aspect, the present invention is a beverage (e.g., a tea, a fruit beverage, a herbal beverage) prepared from a water-soluble film described herein.

In certain embodiments, the water-soluble films are not intended to be eaten directly or consumed before complete dissolution in water to form a beverage. In certain embodiments, the water-soluble films do not comprise pharmaceutical agents or compounds for medicinal purposes. In certain embodiments, the water-soluble films do not comprise alginates or alginate compounds.

### III. Methods for Preparing Water-Soluble Film

In another aspect, the present invention provides methods for preparing the water-soluble films of the present invention.

In one embodiment, a method of preparing a water-soluble film for preparing a beverage comprises:
(i) combining (a) one or more tea, herbal or fruit extracts, (b) a water-soluble polymer, and optionally, (c) a plasticizer, in water or an aqueous solution to form a tea, herbal or fruit extract composition;
(ii) optionally, heating the tea, herbal or fruit extract composition to a temperature in the range of about 25° C. to about 100° C.;
(iii) forming a layer of the tea, herbal or fruit extract composition on a surface;
(iv) drying the layer of the tea, herbal or fruit extract composition to form a water-soluble film.

In certain embodiments, the step of forming a layer of the tea, herbal or fruit extract composition on a surface can be carried out on any passive surface, e.g. a surface which does not interact with the formation of the film other than to provide a shape for the layer of the tea, herbal or fruit composition. In certain embodiments, the surface is a silicone surface.

In certain embodiments, the step of drying the layer of tea, herbal or fruit extract composition may occur in a mold so that the film has a desired shape. In certain embodiments, the method further comprises step (v) shaping the water-soluble film.

In one embodiment, a method of preparing a water-soluble film for preparing a beverage comprises:
(i) combining (a) one or more tea, herbal or fruit extracts, (b) a water-soluble polymer, and optionally, (c) a plasticizer, in water or an aqueous solution to form a tea, herbal or fruit extract composition;
(ii) optionally, heating the tea, herbal or fruit extract composition to a temperature in the range of about 25° C. to about 100° C.;
(iii) forming a layer of the tea, herbal or fruit extract composition on a water-soluble paper;
(iv) drying the layer of the tea, herbal or fruit extract composition to form a water-soluble film.

In certain embodiments, the step of drying the layer of tea, herbal or fruit extract composition may occur in a mold so that the film has a desired shape. In certain embodiments, the method further comprises step (v) shaping the water-soluble film.

In one embodiment, step (i) involves mixing or agitating the tea, herbal or fruit extract composition, for example mixing or agitating the tea, herbal or fruit extract composition for at least about 10 seconds, of at least about 90 seconds. In one embodiment, step (ii) involves mixing or agitating the tea, herbal or fruit extract composition, for example mixing or agitating the tea, herbal or fruit extract composition for at least about 10 seconds, of at least about 90 seconds. Fragrances, sweeteners, flavor agents, color agents and/or fruit acids may be added to the composition, or to components of the composition, during step (i) or at a point in the method prior to heating the tea, herbal or fruit extract composition.

In one embodiment, the water used in the combining of the (a) one or more tea, herbal or fruit extracts, (b) a water-soluble polymer, and optionally, (c) a plasticizer, in water or aqueous solution to form a tea, herbal or fruit extract composition (step (i)) is at a temperature of about 15° C. to about 25° C. In one embodiment, the water or aqueous solution used in the combining of the (a) one or more tea, herbal or fruit extracts, (b) a water-soluble polymer, and optionally, (c) a plasticizer, in water or aqueous solution to form a tea, herbal or fruit extract composition (step (i)) is at a temperature of about 25° C. to about 100° C., about 50° C. to about 95° C., or about 60° C. to about 80° C.

In one embodiment, step (i) is a batch process. In one embodiment, step (ii) is a batch process. In one embodiment, the heating and mixing or agitating of the tea, herbal or fruit extract composition is a batch process.

The steps of forming a layer of the tea, herbal or fruit extract composition on a water-soluble paper; drying the layer of the tea, herbal or fruit extract composition to form a water-soluble film; and shaping the water-soluble film each may be carried out as a batch or continuous process. In certain embodiments, steps (iii), (iv) and/or (v) is may be carried out as a batch process. In certain embodiments, steps (iii), (iv) and/or (v) is may be carried out as a continuous process.

Generally, the forming a layer of the tea, herbal or fruit extract composition on the surface or the water-soluble paper (step iii) can be achieved by any suitable means. For example, the tea, herbal or fruit extract composition may be poured (e.g. via hopper) and scraped to form a layer on a surface or on a water-soluble paper. In certain embodiments, the layer is formed by spray deposition or by slot-die deposition. In certain embodiments, step (iii) comprises casting the tea, herbal or fruit extract composition on to a water-soluble paper. In certain embodiments, step (iii) feeding the tea, herbal or fruit extract composition into a hopper which deposits the tea, herbal or fruit extract composition on to a water-soluble paper. In certain embodiments, the layer of the tea, herbal or fruit extract composition is substantially flat or is formed on a substantially flat surface. In certain embodiments, the layer of the tea, herbal or fruit extract composition is curved or is formed on a curved surface. In certain embodiments, the layer of the tea, herbal or fruit extract composition is poured into a mold to form a desired shape. In certain embodiments, the tea, herbal or fruit extract composition is shaped during the drying step. In certain embodiments, the tea, herbal or fruit extract composition is shaped, for example, folded, after the drying step. curved or is formed on a curved surface. In certain embodiments, the tea, herbal or fruit extract composition is dried completely before the film is shaped. In certain embodiments, the tea, herbal or fruit extract composition is dried partially before the film is shaped, then allowed to dry completely after shaping the film. In certain embodiments, the tea, herbal or fruit extract composition is dried flat and then an amount of moisture re-introduced to it so that it can be easily shaped (e.g. folded or otherwise formed) by hand or machine.

The step of drying the layer of the tea, herbal or fruit extract composition to form a water-soluble film may achieved by allowing the layer of the tea, herbal or fruit extract composition to air dry at ambient temperature, for example at about 15° C. to about 25° C., or by mild heating, for example heating at a temperature of about 25° C. to about 50° C., at ambient pressure. In certain embodiments, the layer of the tea, herbal or fruit extract composition is air dried at a temperature of about 15° C. to about 25° C. for about 1 hour to about 48 hours, or about 12 to about 16 hours, at ambient pressure. In certain embodiments, the layer of the tea, herbal or fruit extract composition is dried by heating at a temperature of about 25° C. to about 50° C. for about 5 min to about 12 hours, at ambient pressure. In certain embodiments, the films are air dried at ambient conditions for any amount of time necessary, for example overnight. In certain embodiments, the films are dried by air drying, forced ventilation (blowing air across), humidity control, appropriate heating e.g. infra-red heater, microwave/convection oven or other convection or radiation methods, or any combination thereof.

The step of shaping the water-soluble film can be achieved by any suitable means, including but not limited to folding, cutting (e.g., laser-cutting, blade-cutting), stamping, molding or any other decorative technique known in the art. In one embodiment, the water-soluble film is shaped by folding to produce a sculpture or desired form, for example as in the art of origami wherein a sheet of paper is shaped into a sculpture through folding and sculpting techniques. In certain embodiments, the water-soluble film is shaped by folding and cutting of the film to produce a sculpture or form, as in the art of Kirigami wherein a sheet of paper is shaped by a combination of folds and cuts to the paper. In certain embodiments, the water-soluble film may be marked with letters, number, symbols or other decorative elements, for example by stamping, cutting or by printing. In one embodiment, the water-soluble film can be layer and adhered with edible glue. In certain embodiments, the final shape of the water-soluble film is a 3-dimensional forms or shapes, such as flowers, leaves, 3-dimensional fruit, woven sheet, spiral, boat, confetti, origami-like shapes, or Kirigami. The forms or shapes may include cut features, folded features and decorative surface features. In certain embodiments, during the step of shaping the water-soluble film, the humidity of the surrounding air is kept below about 50% humidity.

The method can be adjusted as needed to optimize the taste, solubility, flexibility, foldability and surface finish of the water-soluble film, which may vary with types, combinations and proportions of the ingredients in the film.

In certain embodiments, for large scale manufacturing of the films, water-soluble paper can be unwound from large spool with splice and replace method, then is fed through straightening and tensioning equipment (e.g. dancing arm and pinch-pull guides). The tea solution can be fed as a layer onto the water-soluble paper via slot-die or pour and scrape method. The solution and paper are dried to form a film via convection oven or infrared on continuous conveyor. Once the film is dry, it may be cut by rotating or press cutter, and/or folded by a folding machine to produce the final form or shape. Standard pick and place machinery is used to package and pack the shaped films into containers.

The following examples are presented for illustrative purposes only and are not intended to be limiting.

### EXAMPLES

Materials: All components were purchased from commercial sources.

### Example 1: Exemplary Film and Beverage

An exemplary film was prepared using the following method.

An aqueous solution of 12 g freeze dried tea and 0.5 g carrageenan in 100 mL water was prepared. The tea composition was then cast on an A3 sheet of silicone (passive surface) and allowed to dry at ambient temperature and pressure for about 12-16 hours to produce a film.

A film area sufficient to deliver a single serving of freeze-dried tea (0.5 g) was dissolved in just boiled water. Dissolution of the film was occurred immediately. Any remaining residue was dissolved with 10 seconds of agitation.

### Example 2: Exemplary Film and Beverage

An exemplary film was prepared using the following method.

An aqueous solution of 2.5 g freeze dried tea and 3.0 g pullulan in 100 mL water was prepared. The tea composition was then cast on a flat surface and allowed to dry at ambient temperature and pressure for about 12-16 hours to produce a film.

A film area sufficient to deliver a single serving of freeze-dried tea (0.5 g) was dissolved in just boiled water. Dissolution of the film was occurred with 10 seconds of agitation. Small amount of residue was visible.

### Example 3: Exemplary Film and Beverage

An exemplary film was prepared using the following method

An aqueous solution of 12 g freeze dried tea and 0.5 g carrageenan in 100 mL water was prepared. The tea composition was then cast onto an A5 sheet of Smartsolve® water-soluble paper (CMC-starch paper) and allowed to dry at ambient temperature and pressure for about 12-16 hours to produce a film.

A film area sufficient to deliver a single serving of freeze-dried tea (0.5 g) was dissolved in just boiled water. Dissolution of the film was occurred with 10 seconds of agitation. The film completely dissolved and no residue was visible.

### Example 4: Comparative Composition without Tea, Herbal or Fruit Extract

A comparative composition was prepared using the following method.

An aqueous solution of 0.25 g edible food dye and 0.5 g carrageenan in 100 mL water was prepared. The tea composition was then cast onto an A4 sheet of Smartsolve® water-soluble paper (CMC-starch paper) and allowed to dry at ambient temperature and pressure for about 12-16 hours.

No visible film formation was observed. The carrageenan-food dye solution appeared to absorb into the paper leaving a crinkled brittle structure.

### Example 5: Exemplary Films with Plasticizers

Three types exemplary water-soluble films including different types of polyethylene glycol (PEG) were prepared using the following method.

An aqueous solution of freeze dried tea, carrageenan, PEG and KCl in 100 mL water was prepared.

The amounts of the ingredients and type of PEG used are shown in Table 1 below.

TABLE 1

| Film sample/ | Carrageenan | Freeze dried | Plasticizer (type | KCl |
|---|---|---|---|---|
| Ingredients | (amount) | Tea (amount) | and amount) | (amount) |
| Film A | 0.4 g | 10 g | 4 g PEG | 0.025 g |
| | | | 6000 u | |
| Film B | 0.45 g | 10.5 g | 0.45 g PEG | 0.025 g |
| | | | 6000 u | |
| Film C | 0.4 g | 10 g | 4 g PEG | 0.025 g |
| | | | 400 u | |

Each solution of freeze dried tea, carrageenan, PEG and KCl was then cast onto a flat surface, allowed to dry at ambient temperature and pressure for about 12-16 hours to produce a film. and evaluated. The addition of PEG greatly improved deformation before fracture in the resulting films. The resulting films were also more viscous and adhesive to the casting surface than films prepared from solutions without the plasticizer.

### Example 6: Exemplary Shaped Films

Shaped films were prepared by various methods, including but not limited to: folding by hand, cutting with scissors or knife, curving the sheet whilst still humid and allowing to dry shaped, laser-cutting sheets, cutting with die cutter and/or stamp, gluing films together using edible carrageenan glue, stretching and folding the material after moistening it with water mist. Shapes achieved were flowers with layered petals, folded origami leaves and fans, folded and cut lanterns, molded forms in silicone molds such as leaves and flowers.

### Example 7: Large Scale Manufacture of Exemplary Shaped Films

Large scale manufacture of the exemplary films can be prepared using the following method.

0.2 g carrageenan (and/or cellulose and/or pullalan), optionally including a plasticizer, was added to 100 mL of water and heated to 50° C. to form an aqueous solution. 24 g freeze dried tea was added to the aqueous solution and stirred until dissolved, then the aqueous solution was poured directed onto a carboxymethyl cellulose paper with dimensions of 28 cm×22 cm. The film was allowed to air dry overnight at ambient temperature.

The film may then be cut into single or multiple serving sized films.

1. A water-soluble film for preparing a beverage comprising (a) one or more tea, herbal or fruit extracts, (b) a water-soluble polymer, and optionally, (c) a plasticizer.

2. A water-soluble film for preparing a beverage comprising (a) one or more tea, herbal or fruit extracts, (b) a water-soluble polymer, optionally, (c) a plasticizer, and (d) a water-soluble paper.

3. The water-soluble film of claim 1, wherein the water-soluble films dissolves completely in greater than about 80° C. water or near-boiling water.

4. The water-soluble film of claim 1, wherein the water-soluble films may be folded through an angle of 180°.

5. The water-soluble film of claim 1, wherein the tea, herbal or fruit extract, is in the form of freeze-dried tea, liquid tea concentrate, or freshly brewed tea.

6. The water-soluble film of claim 1, wherein the water-soluble polymer is selected from the group consisting of carrageenan, pullulan, carboxymethyl cellulose, starch and mixtures thereof.

7. The water-soluble film of claim 1, wherein the film includes a plasticizer.

8. A method of preparing a water-soluble film for preparing a beverage comprising:
(i) combining (a) one or more tea, herbal or fruit extracts, (b) a water-soluble polymer, and optionally, (c) a plasticizer, in water to form a tea, herbal or fruit extract composition;
(ii) optionally, heating the tea, herbal or fruit extract composition to a temperature in the range of about 25° C. to about 100° C.;
(iii) forming a layer of the tea, herbal or fruit extract composition on a surface or on a water-soluble paper; and
(iv) drying the layer of the tea, herbal or fruit extract composition to form a water-soluble film.

9. (canceled)

10. The method of claim 8, wherein the method further comprises:
(v) shaping the water-soluble film.

11. The method of claim 8, wherein step (i) comprises mixing or agitating the tea, herbal or fruit extract composition.

12. The method of claim 8, wherein step (ii) comprises mixing or agitating the tea, herbal or fruit extract composition.

13. The method of claim 8, wherein step (iii) comprises pouring and scraping, or casting, the tea, herbal or fruit extract composition to form a layer on a surface or on a water-soluble paper.

14. The method of claim 8, wherein step (iv) comprises allowing the layer of the tea, herbal or fruit extract composition to air dry at about 15° C. to about 25° C., or by heating at a temperature of about 25° C. to about 50° C., at ambient pressure.

15. The method of claim 10, wherein step (v) comprises folding, cutting, stamping, or molding.

16. The method of claim 10, wherein step (v) comprises folding the film to produce a sculpture or desired form, or folding and cutting the film to produce a sculpture or desired form.

17. The water-soluble film of claim 2, wherein the water-soluble film dissolves completely in greater than about 80° C. water or near-boiling water.

18. The water-soluble film of claim 2, wherein the water-soluble film may be folded through an angle of 180°.

19. The water-soluble film of claim 2, wherein the tea, herbal or fruit extract, is in the form of freeze-dried tea, liquid tea concentrate, or freshly brewed tea.

20. The water-soluble film of claim 2, wherein the water-soluble polymer is selected from the group consisting of carrageenan, pullulan, carboxymethyl cellulose, starch and mixtures thereof.

21. The water-soluble film of claim 2, wherein the film includes a plasticizer.
